(19) United States
(12) Patent Application Publication
(10) Pub. No.: US 2004/0221880 A1
(43) Pub. Date: Nov. 11, 2004

(54) Substrate treating apparatus

(75) Inventors: Hiroshi Tomita, Yokohama-shi (JP); Soichi Nadahara, Yokohama-shi (JP); Hisashi Okuchi, Ooita-shi (JP); Yusuke Muraoka, Kyoto (JP); Takashi Miyake, Kyoto (JP); Tomonori Kojimaru, Kyoto (JP)

Correspondence Address: OSTROLENK FABER GERB & SOFFEN, 1180 AVENUE OF THE AMERICAS, NEW YORK, NY, 100368403

(73) Assignees: Kabushiki Kaisha Toshiba; Dainippon Screen Mfg. Co. Ltd.

(21) Appl. No.: 10/830,936

(22) Filed: Apr. 23, 2004

(30) Foreign Application Priority Data
Apr. 25, 2003 (JP) JP2003-122266

(51) Int. Cl. B08B 5/00

(52) U.S. Cl. 134/95.1; 134/102.1; 134/103.1; 134/105; 134/111; 134/184; 134/198

(57) ABSTRACT

A substrate treating apparatus for performing a predetermined treatment of substrates. The apparatus includes a holder for holding a plurality of substrates in erected posture, a treating tank for storing hot sulfuric acid at at least 140° C. for treating the substrates immersed therein, and a bubble supply device including a plurality of bubble generating members formed by sintering quartz particles and arranged in the treating tank for generating bubbles of ozone gas such that the bubbles of ozone gas partially overlap one another in a direction parallel to surfaces of the substrates.

### BACKGROUND OF THE INVENTION

(1) Field of the Invention

This invention relates to a substrate treating apparatus for performing a predetermined treatment of semiconductor wafers, glass substrates for photomasks, glass substrates for liquid crystal displays and substrates for optical disks (hereinafter simply called substrates). More particularly, the invention relates to a technique of treating substrates by supplying ozone gas to the substrates immersed in hot sulfuric acid.

(2) Description of the Related Art

In a conventional treatment of semiconductor wafers, the wafers successively undergo an etching process using a treating solution such as a chemical solution, a cleaning process using deionized water, and a drying process. Among these processes, the etching process or stripping process is performed for dissolving and thinning film formed on the surfaces of the semiconductor wafers, or for stripping off the film.

In the etching or stripping process by a conventional substrate treating apparatus, ozone gas is injected into sulfuric acid heated to a high temperature of 120 to 130° C. or higher, and semiconductor wafers are immersed therein. Then, a strong oxidizing substance such as peroxodisulfuric acid synthesized by sulfuric acid and ozone dissolves or strips off unwanted film, particularly resist film, on the surfaces of the semiconductor wafers (see Japanese Unexamined Patent Publication No. 11-174692 (1999), for example).

The conventional apparatus noted above has the following drawbacks.

The conventional apparatus can dissolve or strip off a relatively soft resist film, but has difficulty in coping with hard film implanted with a large quantity of ions during a semiconductor manufacturing process. An expensive ashing system is required to carry out a pretreatment, and the semiconductor wafers must be immersed in a hot solution of sulfuric acid mixed with hydrogen peroxide water to dissolve or strip off unwanted resist film.

Where an ashing system is not used, treatment may be performed by mixing ozone gas into hot sulfuric acid. However, an extended time is taken to dissolve or strip off parts of the film not contacted by ozone gas bubbles. This poses a problem of consuming a long time for the treatment, resulting in low productivity.

A different approach is conceivable for achieving uniform treatment by increasing a supply of ozone gas to generate an increased quantity of bubbles. However, since substrates are simply placed on a holder, the increased quantity of bubbles gives rise to a different problem of the substrates floating off the holder. Thus, such an approach is impracticable.

### SUMMARY OF THE INVENTION

This invention has been made having regard to the state of the art noted above, and its object is to provide a substrate treating apparatus for causing bubbles of ozone gas to contact substrates uniformly, thereby realizing a reduced processing time without using an expensive ashing system.

The above object is fulfilled, according to this invention, by a substrate treating apparatus for performing a predetermined treatment of substrates, comprising:

a holder for holding a plurality of substrates in erected posture;

a treating tank for storing hot sulfuric acid at at least 140° C. for treating the substrates immersed therein; and

a bubble supply device including a plurality of bubble generating members formed by sintering quartz particles and arranged in the treating tank for generating bubbles of ozone gas such that the bubbles of ozone gas partially overlap one another in a direction parallel to surfaces of the substrates.

According to this invention, bubbles of ozone gas are supplied from the bubble generating members to the substrates held by the holder and immersed in hot sulfuric acid stored in the treating tank. The bubble supply device has the bubble generating members for causing the bubbles to partially overlap one another in the direction parallel to the surfaces of the substrates. Thus, no parts of the substrates remain out of contact with the bubbles of ozone gas. The bubbles of ozone gas can uniformly contact the substrates.

In this invention, the bubble generating members, preferably, have a spherical outer shape for generating bubbles uniformly and avoiding deviations of the bubbles.

It is also preferred that the bubble generating members are shaped cylindrical with longitudinal axes thereof extending in a direction of arrangement of the substrates.

The bubble generating members are easy to manufacture where these members have a cylindrical shape with longitudinal axes extending in the direction of arrangement of the substrates.

The bubble supply device, preferably, is switchable for selectively causing the bubble generating members to generate the bubbles.

With this construction, the bubble generating members may be used selectively according to which portions of the surfaces of the substrates should be contacted by the bubbles of ozone gas intensively. Where such switching is made in a direction of arrangement of the substrates, and when the holder holds fewer substrates than its capacity, the bubbles of ozone gas may be supplied only to a portion holding the substrates, thereby saving ozone gas.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an outline of a substrate treating apparatus according to this invention;

FIG. 2 is a plan view schematically showing a bubble supply device;

FIG. 3 is a schematic side view of the bubble supply device seen from a direction perpendicular to surfaces of substrates;

FIG. 4 is a schematic side view of the bubble supply device seen from a direction of arrangement of the substrates;

FIG. 5 is a flow chart of a processing sequence;

FIG. 6 is a flow chart of an etching process;

FIG. 7 is a schematic plan view of a bubble supply device with bubble generating positions switchable in a direction parallel to the substrate surfaces;

FIG. 8 is a side view corresponding to FIG. 7 and seen from the direction perpendicular to the substrate surfaces;

FIG. 9 is a schematic plan view of a bubble supply device with bubble generating positions switchable in the direction of arrangement of the substrates;

FIG. 10 is a perspective view of a modified bubble supply device;

FIG. 11 is a graph showing a relationship between gas flow rate/distance to the substrates and spread of bubbles; and

FIG. 12 is a graph showing a required number of bubble generating elements where 200 mm substrates are treated and a distance between the bubble generating elements and the substrates is 41 mm.

### DESCRIPTION OF THE PREFERRED EMBODIMENTS

An embodiment of this invention will be described hereinafter with reference to the drawings.

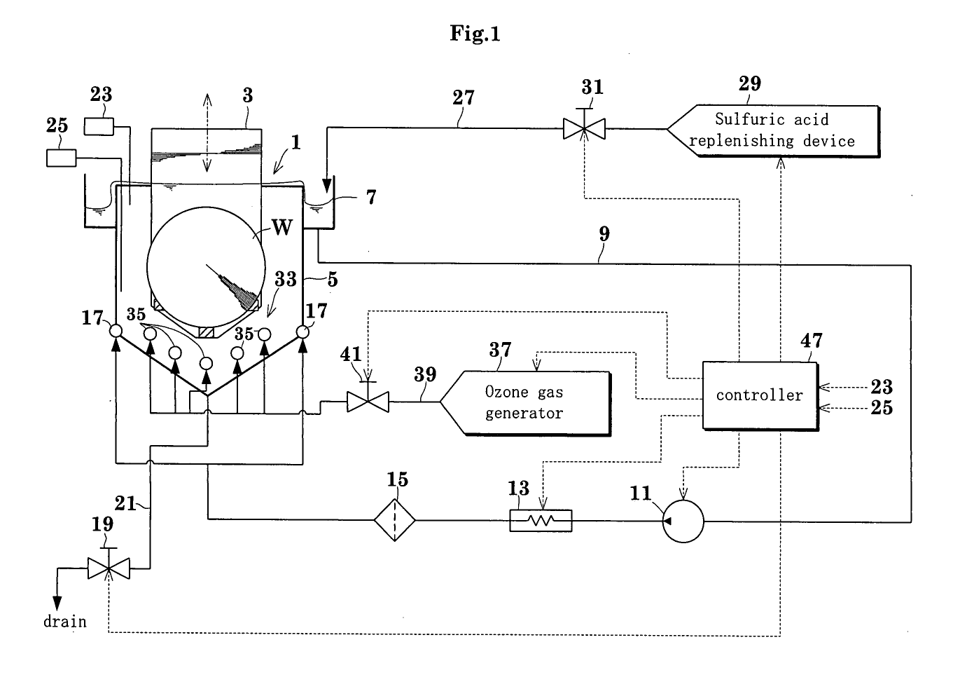

FIG. 1 is a block diagram showing an outline of a substrate treating apparatus according to this invention.

The substrate treating apparatus in this embodiment includes a treating tank 1 for receiving wafers W held by a holder 3. The holder 3 is constructed vertically movable, and transfers wafers W to and from a transport robot not shown. The holder 3 holds a plurality of wafers W in erected posture. The holder 3 is vertically movable between a substrate transfer position above the treating tank 1, which is not shown, and a treating position shown in FIG. 1. The treating tank 1 includes an inner tank 5 and an outer tank 7. The inner tank 5 stores a treating solution, and the outer tank 7 collects overflows of the treating solution. The inner tank 5 and outer tank 7 communicate with each other through piping 9, and the treating solution collected in the outer tank 7 is circulated by a circulating pump 11.

The piping 9 has a heater 13 and a filter 15 arranged downstream of the circulating pump 11. The heater 13 is provided for heating the treating solution to a predetermined temperature (e.g. above 140° C. and about 150-160° C.). The filter 15 removes particles from the treating solution. Discharge pipes 17 are arranged on lower side walls of the inner tank 5 to supply the heated treating solution into the inner tank 5. Piping 21 with a switch valve 19 is connected to the bottom of the inner tank 5 for draining the treating solution from the inner tank 5 by opening the switch valve 19.

The inner tank 5 includes a level sensor 23 and a temperature sensor 25. The level sensor 23 has a function to detect a level of the treating solution in the inner tank 5. The temperature sensor 25 has a function to detect a temperature of the treating solution in the inner tank 5. These sensors 23 and 25 output detection values to a controller 47 described hereinafter.

A forward end of a supply pipe 27 extends into the outer tank 7. The supply pipe 27 is in communication with a sulfuric acid replenishing device 29. A switch valve 31 is operable to supply sulfuric acid which is the treating solution to the outer tank 7.

A bubble supply device 33 is disposed adjacent the bottom of the inner tank 5. The bubble supply device 33, as seen from a direction perpendicular to surfaces of the wafers W, includes five spherical bubble generating elements 35. The spherical bubble generating elements 35, which correspond to the bubble generating members in this invention, are formed by sintering quartz particles and have a function to blow out through numerous pores a gas supplied thereto. The bubble supply device 33 has, connected thereto, piping 39 communicating with an ozone gas generator 37. This piping 39 has a switch valve 41 mounted thereon. When the switch valve 41 is opened, numerous fine bubbles of ozone gas emerge from the spherical bubble generating elements 35.

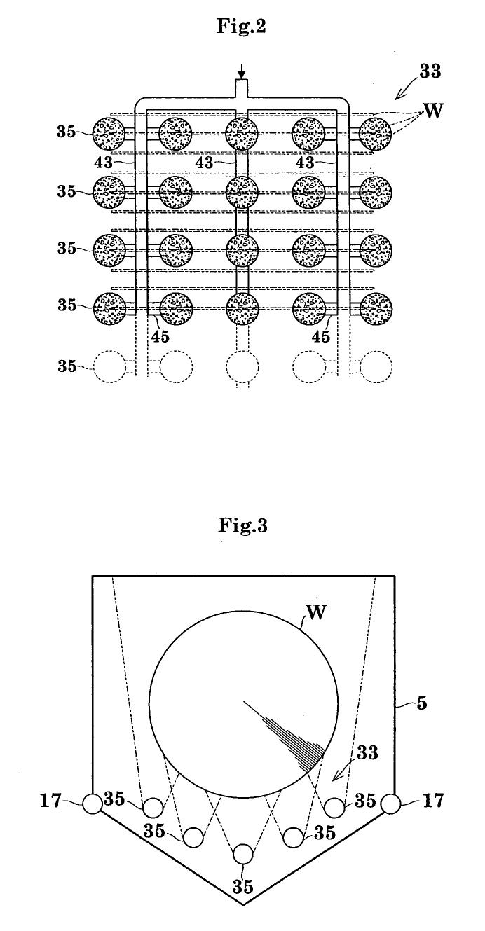

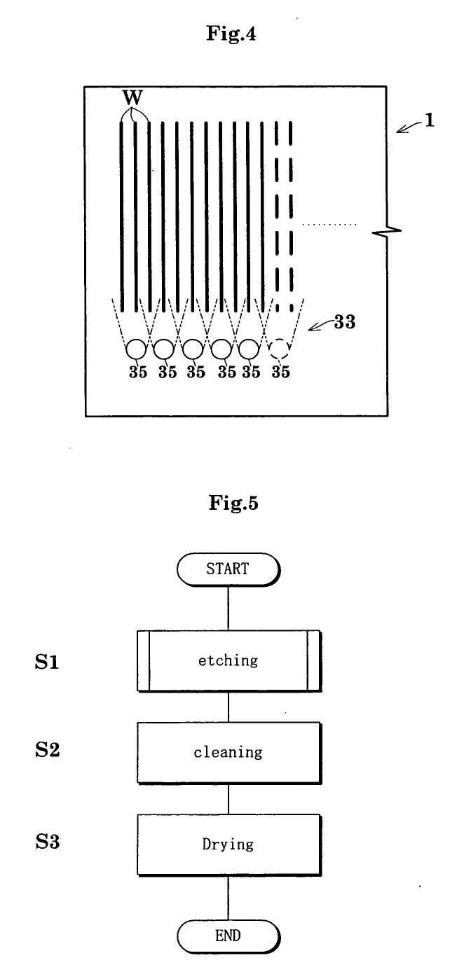

Next, the bubble supply device 33 will be described with reference to FIGS. 2 and 3. FIG. 2 is a plan view schematically showing the bubble supply device 33. FIG. 3 is a schematic side view of the bubble supply device 33 seen from a direction perpendicular to the surfaces of the wafers W. FIG. 4 is a schematic side view of the bubble supply device 33 seen from a direction parallel to an arrangement of wafers W.

The bubble supply device 33 has branch pipes 43, with the spherical bubble generating elements 35 attached to the branch pipes 43 through mounting pipes 45. The branch pipes 43 comprise three pipes, and the mounting pipes 45 are connected to side surfaces or upper surfaces of the branch pipes 43. The plurality of spherical bubble generating elements 35 are arranged in such positions that the bubbles of ozone gas may uniformly contact front and back surfaces of the plurality of wafers W.

Specifically, as seen from the front of the wafers W, the spherical bubble generating elements 35 are arranged arcuately along the outer edges of the wafers W. The two-dot chain lines in FIG. 3 generally indicate loci described by the bubbles of ozone gas generating and rising. In order to leave no parts on the surfaces of wafers W out of contact with the bubbles of ozone gas, the spherical bubble generating elements 35 are arranged so that the loci of ascent of the bubbles generating from adjacent elements 35 may partially overlap one another over the surfaces of wafers W.

As shown in FIG. 4, the spherical bubble generating elements 35 are arranged so that the loci of ascent of the bubbles generating from adjacent elements 35 may partially overlap one another also in the direction of arrangement of the wafers W. Consequently, when a plurality of wafers W are treated simultaneously, variations occurring from wafer to wafer are avoided to effect uniform treatment for all wafers W.

FIG. 1 refers again.

Based on detection values received from the level sensor 23 and temperature sensor 25, for example, the controller 47 controls the circulating pump 11, switch valve 19, heater 13, sulfuric acid replenishing device 29, switch valve 31, ozone gas generator 37 and switch valve 41. This control is performed according to a predetermined recipe.

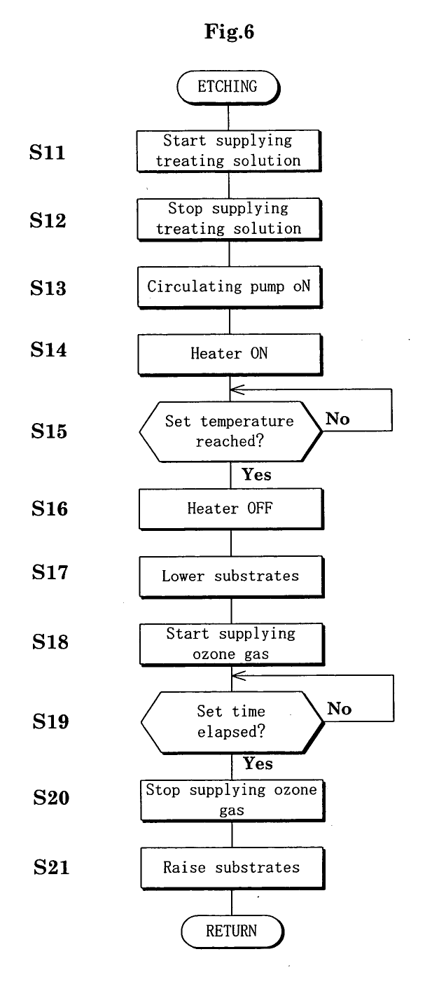

Operation of the above substrate treating apparatus will be described next with reference to FIGS. 5 and 6. FIG. 5 is a flow chart of a processing sequence. FIG. 6 is a flow chart of an etching process. In the following description, etching will be taken as a specific example of treatment.

In sum, an etching process is performed in step S1 for chemically treating the wafers W, then a cleaning process in step S2 by using deionized water, and finally a drying process in step S3. The cleaning process using deionized water in step S2 and drying process in step S3 are carried out in other treating tanks.

Step S11

The controller 47 opens the switch valve 31 to start supplying sulfuric acid, which is the treating solution herein, from the sulfuric acid replenishing device 29 to the treating tank 1. The holder 3 holding the wafers W is on standby above the treating tank 1, and the switch valve 19 remains closed.

Step S12

Based on a detection value from the level sensor 23, the controller 47 determines a supplied quantity of sulfuric acid, and closes the switch valve 31 according to this quantity to stop the supply of sulfuric acid.

Step S13

The circulating pump 11 is operated to circulate the sulfuric acid supplied to the treating tank 1.

Step S14

The heater 13 is controlled to start a temperature control for adjusting the temperature of the treating solution in circulation to a predetermined temperature (which is a target value of the temperature control, e.g. 150° C.).

Step S15

Based on a detection value from the temperature sensor 25, the controller 47 takes one of alternative courses of action. That is, when the target value of the temperature control has been reached, the operation moves to the following step S16. Otherwise, step S15 is repeated.

Step S16

When the temperature control is completed, the heater 13 is turned off once.

In the event of a temperature fall occurring during the treatment, the controller 47, preferably, operates the heater 13 based on detection values from the temperature sensor 25 to stabilize temperature.

Step S17

The holder 3 is lowered to place the plurality of wafers W held thereon in the treating tank 1.

Step S18

The controller 47 opens the switch valve 41 as the holder 3 is lowered to the treating position. As a result, bubbles of ozone gas are supplied from the bubble supply device 33 to the wafers W. At the same time, the controller 47 starts measuring the passage of processing time.

Step S19

The operation branches depending on whether a predetermined time (processing time) specified in the recipe has passed.

That is, when the processing time has not expired, step S19 is repeated. Otherwise, the operation moves to the following step S20.

Step S20

The controller 47 closes the switch valve 41 to stop supplying ozone gas to the wafers W.

Step S21

The controller 47 raises the holder 3 from the treating position to the transfer position. The wafers W are moved by the transport robot, not shown, to the treating tank for the cleaning process to wash sulfuric acid off the wafers W (step S2). Subsequently, the wafers W are moved by the transport robot to the treating tank for the drying process to be dried therein (step S3).

The switch valve 41 may be opened before step S17 to execute a step of dissolving ozone gas to a point of saturation in the sulfuric acid circulating to the treating tank 1.

The apparatus in this embodiment performs the etching process of wafers W through the above series of processing steps. In this embodiment, the bubble supply device 33 has the bubble generating elements 35 for causing the bubbles partially overlapping one another over the surfaces of wafers W. Thus, no parts of the surfaces of wafers W remain out of contact with the bubbles of ozone gas. The bubbles of ozone gas can uniformly contact the surfaces of wafers W in the direction parallel to the surfaces of the wafers W. This realizes a reduced processing time without using an expensive ashing system.

Further, the bubble supply device 33 is constructed for causing the bubbles of ozone gas to contact a plurality of wafers W evenly also in the direction of arrangement of the wafers W. When simultaneously treating a plurality of wafers W, the same advantage as above is realized to treat the wafers W uniformly.

In FIG. 2, the pipes of the bubble supply device 33 are arranged to diverge as a whole from ozone gas supply ports, and terminate in the form of individual pipes. The pipes may be connected to one another at terminal ends thereof to uniform an overall pressure in the piping for further equalizing the bubbles.

The above bubble supply device 33 may be modified as follows.

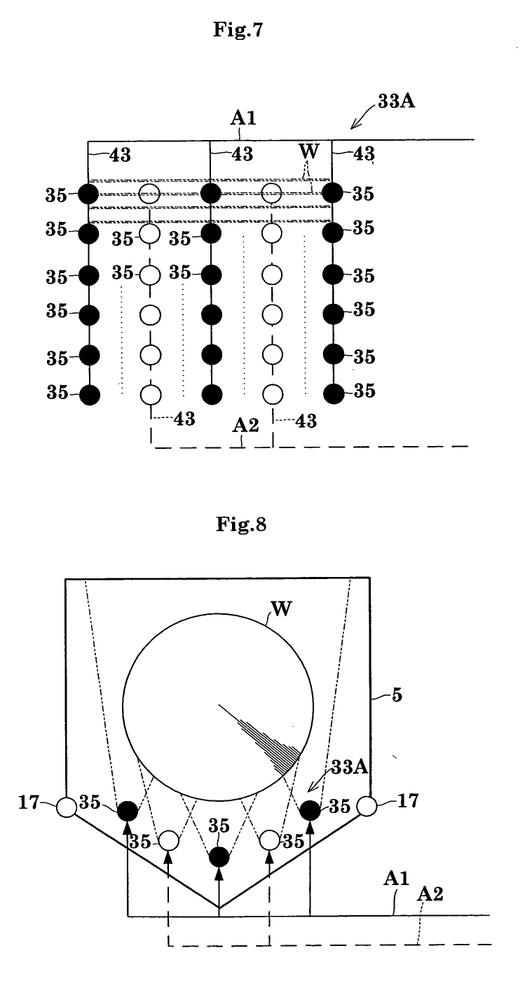

Reference is made to FIGS. 7 and 8. FIG. 7 is a schematic plan view of a bubble supply device with bubble generating positions switchable in a direction parallel to the substrate surfaces. FIG. 8 is a side view corresponding to FIG. 7 and seen in the direction perpendicular to the substrate surfaces.

A bubble supply device 33A has bubble generating elements 35 controllable to generate bubbles according to their positions in the direction parallel to the surfaces of wafers W. That is, the branch pipes 43 are divided into two groups, group A1 and group A2, independently controllable to supply ozone gas.

With this construction, the bubble generating elements 35 for generating bubbles may be switched according to positions on the surfaces of wafers W. The progress of treatment may vary with positions along the surfaces of wafers W. Even in such a case, uniform treatment may be achieved by switching the groups A1 and A2 for supplying ozone gas. When progress is slower in the central parts and right and left ends than the parts therebetween of wafers W, ozone gas is supplied in an increased quantity or for an extended time to group A1. Conversely, ozone gas may be supplied in a less quantity or for a shorter time to group A2 than to group A1.

While supplying ozone gas to group A1, the supply of ozone gas to group A2 may be reduced instead of being stopped.

Naturally, switching may be made among five groups to provide a more elaborate control of bubble contact areas. The spherical bubble generating elements 35 may be in two, three, four, six or more rows juxtaposed in the direction parallel to the surfaces of wafers W. Then, switching may be made among groups formed according to the number of rows.

The above example is a control of ozone gas bubbles made in the direction parallel to the surfaces of wafers W. The following control may be made in the direction of arrangement of wafers W.

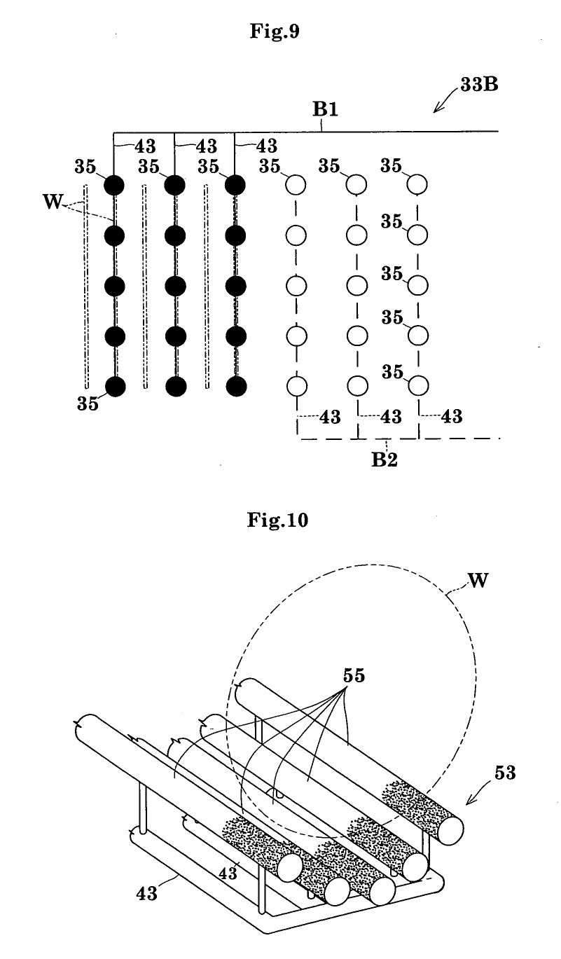

Reference is now made to FIG. 9. FIG. 9 is a schematic plan view of a bubble supply device with bubble generating positions switchable in the direction of arrangement of wafers W.

A bubble supply device 33B has bubble generating elements 35 controllable to generate bubbles according to their positions in the direction of arrangement of wafers W. For example, the branch pipes 43 are divided into two groups, group B1 and group B2, independently controllable to supply ozone gas. Where the holder 3 holds 50 wafers W, for example, each of the two switchable groups corresponds to an area including 25 consecutive wafers W.

With this construction, when the holder 3 holds fewer wafers W for simultaneous treatment than the number of wafers W that can be held, ozone gas bubbles need not be generated for a location where no wafers are present. Thus, a wasteful use of ozone gas may be inhibited. It is also possible to inhibit energy consumption for treating exhaust ozone gas. This enables compactness and cost reduction of ozone gas treating equipment.

Even when the holder 3 holds wafers W to capacity, and when an allowance is available in processing time, switching may be made between a plurality of groups although this requires an extended time. This will reduce the concentration of exhaust ozone gas to allow for compactness and cost reduction of ozone gas treating equipment.

In the foregoing embodiment, the bubble supply devices 33, 33A and 33B have the spherical bubble generating elements 35 as bubble generating members. Such devices may be replaced with a bubble supply device 53 as shown in FIG. 10. FIG. 10 is a perspective view showing a modified bubble supply device.

This bubble supply device 53 has cylindrical bubble generating elements 55 whose longitudinal axes extend in the direction of arrangement of the wafers W. The cylindrical bubble generating elements 55 are formed by sintering quartz particles to cylindrical shape. Compared with the spherical elements described above, this construction can supply bubbles of ozone gas with increased uniformity to the wafers W. Further, the cylindrical bubble generating elements 55 have an advantage over the spherical elements in being easy to manufacture.

Bubble regions of ozone gas produced by the bubble supply device 53 have the larger area, the greater the distance is between the bubble generating members and the wafers W. Thus, by enlarging the distance, the number of bubble generating members used or provided may be reduced. However, the treating tank 1 must be enlarged in proportion to the distance. It is therefore desirable to determine an appropriate distance by taking the quantity of the treating solution and compactness of the apparatus into consideration.

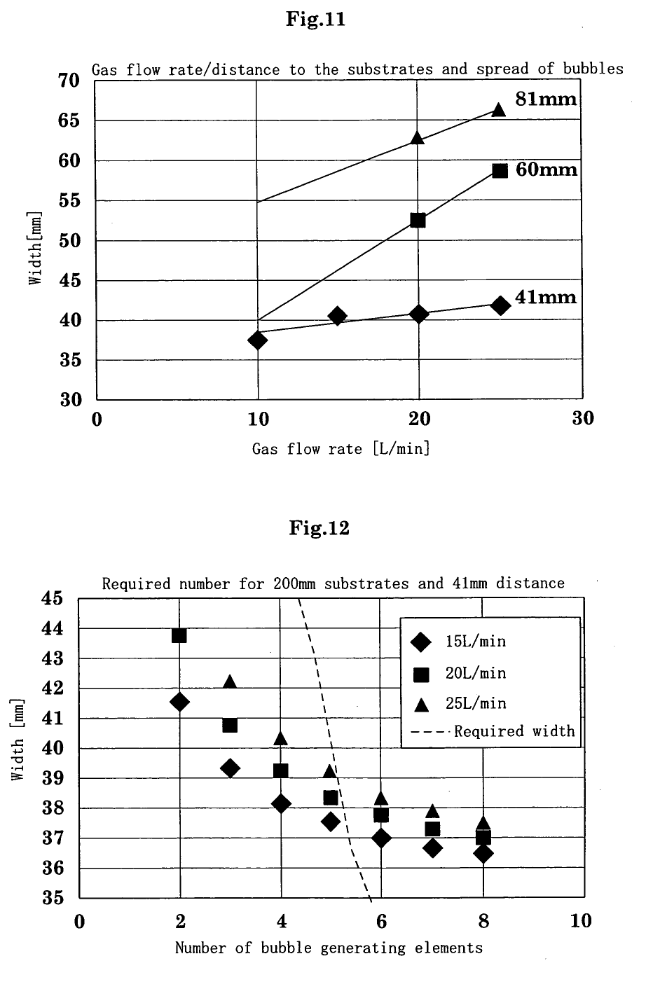

FIGS. 11 and 12 illustrate an arrangement based on this embodiment of the spherical bubble generating elements with a required diameter of about 20 mm.

FIG. 11 shows widths of bubbles generating from the bubble generating device dependent on the distance to the wafers W when the flow rate of ozone gas is varied from 10 L/min. to 25 L/min. Where a conventional tank was used, the distance of the bubble generating device to the wafers W was 41 mm. The flow rate of ozone gas was 20 L/min. when the wafers W stood against floating due to the bubbles generated in a treating solution of high specific gravity (1.83). At this time, the bubbles adjacent the wafers W had widths about 40 mm.

FIG. 12 shows relationships between a necessary minimum width of bubbles and the number of bubble generating elements, and between the flow rate of ozone gas and the bubbles. It is seen that, when the flow rate of ozone gas is in the range of 15 to 20 L/min., at least six bubble generating elements are required for causing the bubbles to overlap one another and uniformly contact the wafers W. In this way, the number and arrangement of bubble generating elements for uniformly directing ozone gas to the wafers W may be determined.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating apparatus for performing a predetermined treatment of substrates, comprising:
a holder for holding a plurality of substrates in erected posture;
a treating tank for storing hot sulfuric acid at at least 140° C. for treating said substrates immersed therein; and
bubble supply means including a plurality of bubble generating members formed by sintering quartz particles and arranged in said treating tank for generating bubbles of ozone gas such that said bubbles of ozone gas partially overlap one another in a direction parallel to surfaces of said substrates.

2. An apparatus as defined in claim 1, wherein said bubble generating members are shaped spherical.

3. An apparatus as defined in claim 1, wherein said bubble generating members are shaped cylindrical with longitudinal axes thereof extending in a direction of arrangement of said substrates.

4. An apparatus as defined in claim 1, wherein said bubble supply means is switchable for selectively causing said bubble generating members to generate the bubbles.

5. An apparatus as defined in claim 2, wherein said bubble supply means is switchable for selectively causing said bubble generating members to generate the bubbles.

6. An apparatus as defined in claim 3, wherein said bubble supply means is switchable for selectively causing said bubble generating members to generate the bubbles.

7. An apparatus as defined in claim 4, wherein said bubble supply means further includes a plurality of branch pipes communicating with said bubble generating members to form groups distributed to different positions in said direction parallel to the surfaces of said substrates, said groups supplying the bubbles independently of each other.

8. An apparatus as defined in claim 5, wherein said bubble supply means further includes a plurality of branch pipes communicating with said bubble generating members to form groups distributed to different positions in said direction parallel to the surfaces of said substrates, said groups supplying the bubbles independently of each other.

9. An apparatus as defined in claim 6, wherein said bubble supply means further includes a plurality of branch pipes communicating with said bubble generating members to form groups distributed to different positions in said direction parallel to the surfaces of said substrates, said groups supplying the bubbles independently of each other.

10. An apparatus as defined in claim 4, wherein said bubble supply means further includes a plurality of branch pipes communicating with said bubble generating members to form groups distributed to different positions in a direction of arrangement of said substrates, said groups supplying the bubbles independently of each other.

11. An apparatus as defined in claim 5, wherein said bubble supply means further includes a plurality of branch pipes communicating with said bubble generating members to form groups distributed to different positions in a direction of arrangement of said substrates, said groups supplying the bubbles independently of each other.

12. An apparatus as defined in claim 6, wherein said bubble supply means further includes a plurality of branch pipes communicating with said bubble generating members to form groups distributed to different positions in a direction of arrangement of said substrates, said groups supplying the bubbles independently of each other.

13. An apparatus as defined in claim 7, wherein said bubble supply means is arranged to provide a varied ozone gas supply time for each of said groups.

14. An apparatus as defined in claim 8, wherein said bubble supply means is arranged to provide a varied ozone gas supply time for each of said groups.

15. An apparatus as defined in claim 9, wherein said bubble supply means is arranged to provide a varied ozone gas supply time for each of said groups.

16. An apparatus as defined in claim 10, wherein said bubble supply means is arranged to provide a varied ozone gas supply time for each of said groups.

17. An apparatus as defined in claim 11, wherein said bubble supply means is arranged to provide a varied ozone gas supply time for each of said groups.

18. An apparatus as defined in claim 12, wherein said bubble supply means is arranged to provide a varied ozone gas supply time for each of said groups.

19. An apparatus as defined in claim 1, wherein said treating tank includes an inner tank, and an outer tank for collecting the hot sulfuric acid overflowing said inner tank, said inner tank and said out tank communicating with each other through piping.

20. An apparatus as defined in claim 19, wherein said piping includes a circulating pump for circulating said hot sulfuric acid from said outer tank to said inner tank.
